(19) United States
(12) Patent Application Publication
(10) Pub. No.: US 2013/0032002 A1
(43) Pub. Date: Feb. 7, 2013

(54) Vibration Arrangement for a Vehicle Steering Wheel

(71) Applicant: Klas Küntzel, Djursholm (SE)

(72) Inventor: Klas Küntzel, Djursholm (SE)

(73) Assignee: AUTOLIV DEVELOPMENT, SE-447 Vargarda (SE)

(21) Appl. No.: 13/640,964

(22) PCT Filed: Apr. 4, 2011
(86) PCT No.: PCT/SE11/50396

§ 371 Date: Oct. 12, 2012

(30) Foreign Application Priority Data
Apr. 13, 2010 (SE) 1050359-7

(51) Int. Cl. B60W 50/16; B62D 1/06

(52) U.S. Cl. 74/558

(57) ABSTRACT

A vibration arrangement for a vehicle steering wheel includes at least one steering wheel vibrator assembly at or in the ring of the steering wheel, the steering wheel ring having a metallic part that is mechanically coupled to a steering wheel hub and where the at least one vibrator assembly is arranged to produce a frequency of vibration. The vibrator assembly includes a vibrator coupled to an elongate ring-shaped vibration body, arranged to lie around at least a majority of the steering wheel ring without being in contact with the metallic part of the steering wheel ring. The vibration body is arranged to be positioned close to an external surface cover of the steering wheel, which a driver grips while controlling the vehicle. The vibrator assembly can produce a vibration to alert the driver.

### CROSS-REFERENCE TO RELATED APPLICATIONS

This application claims priority to Sweden Patent Application 1050359-7, filed Apr. 13, 2010 and PCT/SE2011/050396, filed Apr. 4, 2011.

### FIELD OF THE INVENTION

The present invention concerns a vibration arrangement for a vehicle steering wheel.

The present invention is included as an important part of an active safety system for motor vehicles. In such a system, there are included a detection component, which detects situations of impending danger, and a calculation component, which raises an alarm. This alarm takes place in a warning component, which warns the driver when danger has been detected. The warning component may use a steering wheel vibrator according to the invention.

### BACKGROUND OF THE INVENTION

The development of active safety systems for motor vehicles has focused on not only the detection of traffic dangers but also on suitable driver alarms in various situations of danger. The alarms that have been tested have been visual, acoustic, and haptic alarms, and combinations of these.

Different types of alarms may prove to be more suitable and effective depending on the traffic situation.

Visual alarms can be used in a traffic situation in which the driver is fully awake and alert, but become completely ineffective if the driver has fallen asleep or is in the process of falling asleep. Acoustic alarms are less appropriate in situations in which the driver has impaired hearing or in which the surrounding noise level is high.

Both acoustic and haptic alarms can be used in cases in which the driver falls into a short-lived or unbroken sleep. A haptic alarm in the form of mechanical vibration in the steering wheel has the major advantage over both an acoustic alarm and a haptic alarm located in other locations, such as in the seat belt or in the driver's seat, in that the feeling of vibration in the hands and fingers of the driver leads to an immediately and distinct grip on the steering wheel, while the driver is at the same time awakened, as has been described in WO 2007/136 338 A1. The present invention uses this knowledge.

Many different ways of creating vibration in a vehicle steering wheel are known. Arrangements based on electromagnetic or piezoelectric vibrators have been described with the installation of such between a fixed point in the vehicle and the shaft of the steering wheel, or between the center part of the steering wheel and its spokes, or between the spokes of the steering wheel and its ring. Imbalance motors are known, whose installation is normally in direct physical contact with some part of the supporting metal structure of the steering wheel, for example a spoke, or for installation onto the steering wheel. A further previously known arrangement uses piezoelectric layers at some part of the outer cover of the steering wheel, with piezoelectric crystals or piezoelectric tape.

In order for the vibration to be experienced around the complete ring of the steering wheel, it has been suggested that the complete metallic part of the steering wheel be placed into an oscillation condition. This requires, however, an equivalent electromechanical power in a vibrator in order to achieve the vibration. Furthermore, the complex geometry of the steering wheel leads to vibration in several directions, which, together with different resonance frequencies in different parts of the steering wheel, easily creates phase distortions and irregular oscillation modes. It is therefore very complicated to produce vibration that corresponds to a desired frequency in the surface of the steering wheel.

Experience shows, in addition, that the maxima of amplitude vary in an undesired manner around the ring of the steering wheel when the known methods of installing vibrators are used.

The steering wheel vibrator is primarily suited to be an integral part of a vehicle steering wheel, but it can be designed also to be a part of externally mounted supplementary equipment on a vehicle steering wheel such as in a cover, which can also contain a detection component and a calculation component.

The present invention consists of a vibration arrangement that removes the disadvantage of a large vibration body, which the metal structure of the steering wheel is, and thus removes the requirement for a powerful vibrator, the disadvantage of poor distribution of vibration in the irregular body, and the disadvantage of oscillatory interference. Furthermore, the present invention offers the possibility of achieving a desired vibratory effect in the surface of the steering wheel independently of the design of the steering wheel.

The present invention thus relates to a vibration arrangement for a vehicle steering wheel comprising one or more vibrators mounted to a ring of the steering wheel, the ring having a metallic part that is mechanically coupled to a steering wheel hub, and where at least one vibrator is arranged to produce a vibration frequency, wherein the vibrator is attached to a vibration body, wherein the vibration body is elongated, wherein the vibration body extends around at least a majority of the ring of the steering wheel without being in contact with the metallic part of the ring of the steering wheel, and wherein the vibration body is positioned close to the external surface cover that a driver grips when driving the vehicle.

A vibration arrangement according to the invention for a vehicle steering wheel comprises one or more vibrators at or in the ring of the steering wheel. A vibration body and a vibrator can be arranged to be electrically connected to a source of voltage. The vehicle steering wheel has a ring with a metallic part that is mechanically coupled with a steering wheel hub. The metallic part of the ring of the steering wheel can be connected to spokes that pass to a steering wheel hub. At least one vibrator is arranged to produce a vibration frequency in the vibration body.

The vibrator can be, according to the invention, coupled to the vibration body. The vibration body can be elongated and arranged to extend around at least a majority of the complete ring of the steering wheel without being in contact with the metallic part of the ring of the steering wheel. The vibration body can be arranged to be positioned close to the external surface cover that a driver grips when controlling the vehicle.

In one form, the vibration body is in the form of a rod.

In one form, the vibration body has two free ends and the vibrator is mounted at one of the free ends.

In one form, the vibrator is attached at the two free ends of the vibration body such that a closed ring is formed.

In one form, the vibration body is a closed ring, and the vibrator is mounted to the closed ring.

In one form, the vibrator is an imbalance motor coupled with the vibration body, joined to form a single unit.

In one form, the vibration body is made of metal.

In one form, in which one or more vibrators are integrated with the steering wheel, the diameter of each ring-shaped vibration body coupled to the vibrator is less than the outer diameter of the steering wheel and greater than its inner diameter.

In one form, two more vibrators are each coupled to an individual vibration body.

In one form, the individual vibrations bodies lie separated from each other.

In one form, one of the two or more vibrators is located close to the upper side of the steering wheel ring, and another of the two or more vibrators is located close to the lower side of the steering wheel ring, and the vibrators are configured to operate at different angular frequencies.

In one form, the vibration body is mechanically coupled with an imbalance motor that is encapsulated in a suitable manner. A vibration arrangement according to the invention contains at least one ring-shaped vibration body, which can also be referred to as a “vibrator ring”, which is coupled with the cover of at least one imbalance motor. The vibration arrangement is an integrated part of a vehicle steering wheel and is installed inside the ring of the steering wheel close to its outer cover.

In another form, the vibration body, or vibrator ring, and its encapsulated vibrator, or imbalance motor, are located inside a specially designed cover, wherein this cover can be mounted onto an existing steering wheel in a motor vehicle. The integration of the steering wheel vibrator with the cover can be designed in a similar manner in order to allow vibration even when hard hand pressure influences the cover.

In one form, the one or more vibrator and the one or more vibration body are arranged such that the external surface cover of the ring of the steering wheel vibrates with a frequency and an amplitude such that the Pacinian or Meissner corpuscles in the fingers or hands of the driver are stimulated.

The embodiments according to the invention are based on a similar vibration arrangement comprising an imbalance motor, or vibrator, and an open or closed vibrator ring, or vibration body, coupled with it. It is an aspect of the solution and the invention that the ring can be designed with respect to material, mass and cross-sectional form in such a manner that the desired amplitude is achieved at a selected degree of imbalance and a selected rate of revolution of the motor, which determines the applied vibration frequency.

### BRIEF DESCRIPTION OF THE DRAWINGS

So that the invention may be more readily understood, and so that further features thereof may be appreciated, embodiments of the invention will now be described by way of example with reference to the accompanying drawings in which:

FIG. 1 is a plan view of a freed steering wheel vibrator assembly;

FIG. 2 is an enlarged partial plan view of a vibrator of the vibrator assembly of FIG. 1;

FIG. 3 is a plan view of a vehicle steering wheel with the steering wheel vibrator assembly;

FIG. 4 is a cross-sectional view of the vehicle steering wheel taken along line A-A of FIG. 3;

FIG. 5 is a plan view of another steering wheel with another steering wheel vibrator assembly;

FIG. 6 is a cross-sectional view of the steering wheel of FIG. 5 taken along line B-B;

FIG. 7 is a cross-sectional view of the steering wheel of FIG. 5 taken along line C-C;

FIG. 8 is a plan view of a steering wheel vibrator assembly mounted in a cover for a steering wheel, and

FIG. 9 is a cross-sectional view of the cover taken along line D-D.

### DETAILED DESCRIPTION OF THE PREFERRED EMBODIMENTS

The object of the invention is to be able to generate in an efficient and controlled manner haptic vibration signals around the ring of a steering wheel to the driver of a motor vehicle, where the driver's hands and fingers grip the steering wheel.

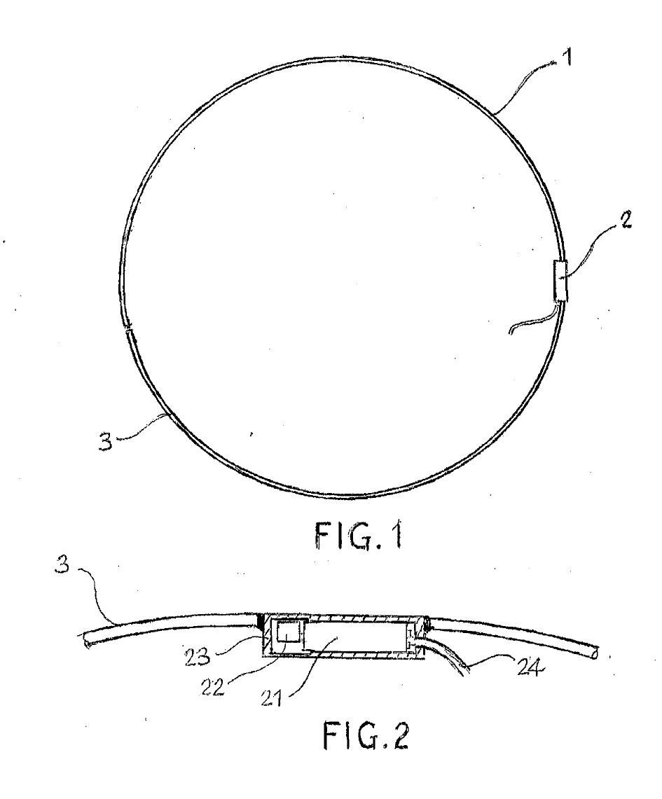

FIG. 1 shows a steering wheel vibrator assembly 1 including a vibrator 2 and a ring-shaped vibration body 3. FIG. 2 shows the central parts of the vibrator 2, where 21 denotes an imbalance motor, 22 denotes an imbalance element, 23 denotes a protective cover, 24 denotes electrical conductors, and 3 denotes the vibration body 3 of the steering wheel vibrator assembly 1.

The motor unit or vibrator 2 of the steering wheel vibrator assembly 1 in FIGS. 1 and 2 is mechanically mounted to the vibration body 3 through brazing or welding or other known technology, such that the motor shaft of the imbalance motor 21 is parallel with the tangential direction of the vibration body 3 at the point of attachment.

As is shown in FIG. 2, the vibrator 2 comprises the motor 21 with its displaceable imbalance element 22 and the protective cover 23, which is mounted to the motor 21 and arranged so that the imbalance element 22 can rotate freely.

The cross-sectional area of the ring-shaped vibration body 3 shown in FIGS. 1 and 2 is circular, but it may also have another form and it may be selected, for example, such that the desired vibration is primarily directed towards the normal of the external surface cover of the steering wheel after installation. The ring-shaped vibration body 3 should oscillate most easily in a direction that is perpendicular to the longest side of the cross-sectional area.

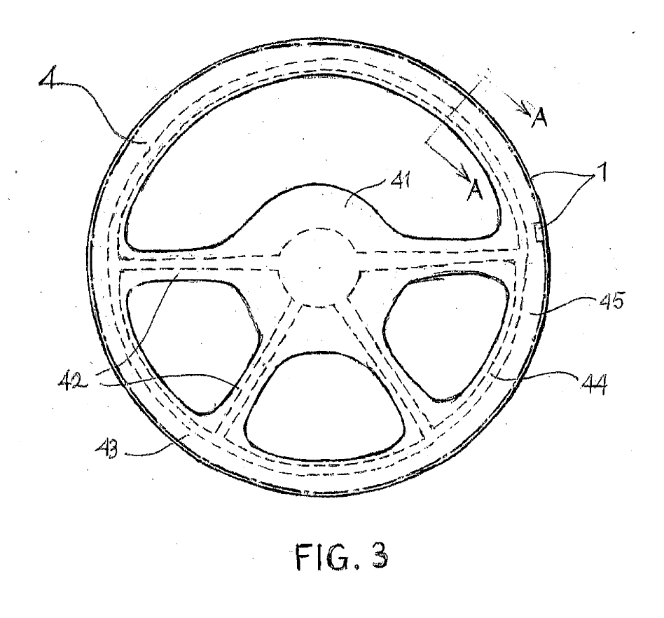

In FIG. 3, the reference number 4 denotes a steering wheel of a motor vehicle, 41 its central part, 42 its spokes, 43 the ring of the steering wheel, 44 a metallic supporting structure of the steering wheel, and 45 a soft outer cover of the steering wheel, which cover 45 is fixed at the metallic supporting structure 44 of the steering wheel 4.

The outer cover 45 of the steering wheel has been drawn in FIG. 3 with full lines and the metal supporting structure 44 of the steering wheel with dashed lines, while the steering wheel vibrator assembly 1, with its vibrator 2 and vibration body 3, has been drawn with dot-dashed lines. The steering wheel 4 in this design is provided with the steering wheel vibrator assembly 1, which is located close to the outer diameter of the steering wheel 4.

According to one highly preferred embodiment, the elongate vibration body 3 is arranged in or on the ring 43 of the steering wheel 4. Furthermore, the vibration body 3 and the vibrator 2 are surrounded by a soft and flexible material.

According to a significant embodiment, the vibration body 3 is arranged in a track or a groove 451, located in the ring 43 of the steering wheel 4 under the outer cover 45 of the ring 43.

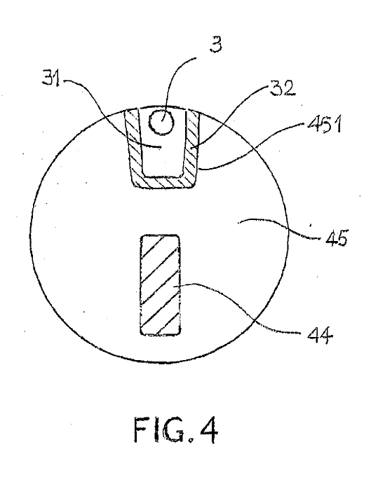

The reference number 451 in FIG. 4 denotes the groove in the ring 43 of the steering wheel 4, 31 denotes a soft spacer material, and 32 a shock-absorbing reinforcement, of a suitable material, for the walls of the groove 451.

FIG. 4, which shows an enlarged cross-section A-A in FIG. 3, shows how the vibration body 3 is oriented in the groove 451 in the outer cover 45 of the ring 43 of the steering wheel 4, which generally lies around the complete circumference of the ring 43 of the steering wheel 4. The location of the vibration body 3 in the groove 451 is such that the vibration body 3 can vibrate easily, without large counteracting forces from the walls of the groove 451, and such that the vibration is not easily propagated to these walls. It is preferred that the vibration body 3 be held in place by means of a soft and flexible spacer material 31 between the vibration body 3 and the walls of the groove 451. It is preferred that the spacer material 31 be plastic. During manufacture, the vibration body 3 and its flexible spacer material 31 can be provided with an outer cover 32 that forms a wall at the site of plastic injection at the steering wheel 4, such that the outer cover 45 of the steering wheel 4 conceals the vibration body 3. That which has been described here is valid to the same extent for the vibrator 2 that is fixed at the vibration body 3.

According to one preferred embodiment, more than one vibrator 2 is present, where one of the vibrators 2 is coupled to a first vibration body 11 and another vibrator 2 is coupled to a second vibration body 12. It will be appreciated that additional vibrators could be coupled to additional vibration bodies.

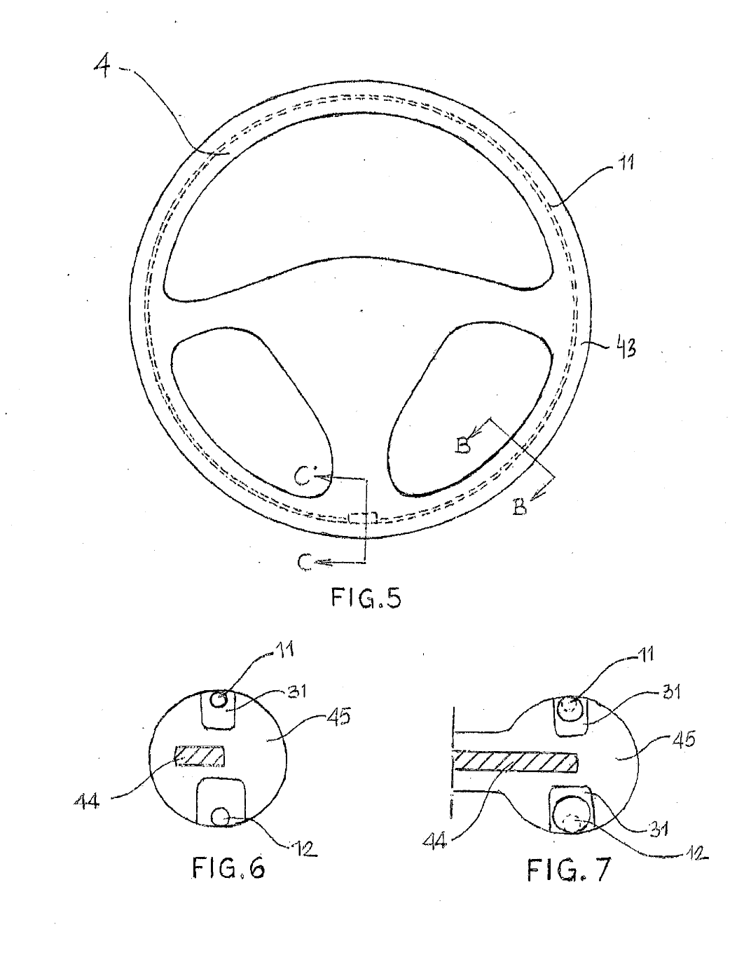

In this approach, the vibration bodies 11 and 12 lie separated from each other, and each one of the first and second vibration bodies 11 and 12 is coupled to its respective vibrator 2, as shown in FIGS. 6 and 7.

In this approach, the first vibration body 11 is located close to the upper side of the ring 43 of the steering wheel 4 and the second vibration body 12 is close to the lower side of the steering wheel 4. These first and second vibration bodies 11 and 12, along with their respective vibrators 2, are designed such that they can operate at different angular frequencies.

FIGS. 5-7 show a design of steering wheel vibrators 2 installed in the steering wheel 4. The steering wheel 4 for a passenger vehicle with three spokes is shown in this case as an example. The metallic supporting structure 44 of the steering wheel 4 has been omitted from FIG. 5 for reasons of clarity. This variant shows an example of how a steering wheel can be designed with the aid of the invention to have, at the same time, haptic alarms with two different frequencies with limited interference between the two frequencies.

The reference number 11 in FIGS. 5-7 denotes the first steering wheel vibration body that operates at a first angular frequency ω₁ and the reference number 12 denotes the second steering wheel vibration body, that operates at a second angular frequency ω₂.

FIG. 5 shows in a view from above a vehicle steering wheel 4 and a steering wheel vibration body 11, shown with dashed lines, that lies inside it. FIG. 6 shows a cross-section B-B of the ring 43 of the steering wheel 4, where it is clear that the upper side of the steering wheel 4 is provided with the first vibration body 11, and the lower side of the ring 43 of the steering wheel 4 is provided with the second steering wheel vibration body 12. The metallic supporting structure 44 of the steering wheel 4 is suggested with oblique hatching cross-section in FIGS. 6 and 7.

The uppermost steering wheel vibration body 11, which operates at the angular frequency ω₁, lies in a groove at the upper side of the ring 43 of the steering wheel 4, while the lower steering wheel vibration body 12, which operates at the angular frequency ω₂, is located in a groove at the lower side of the ring 43 of the steering wheel 4. Both steering wheel vibrators 11 and 12 are at the boundary of the respective side of the outer cover 45 of the ring 43 of the steering wheel 4, which cover 45 thus absorbs the vibration ω₁ at the upper side and the vibration ω₂ at the lower side. Both vibration bodies 11 and 12 have free mobility on other sides since they are bounded by a very flexible spacer material 31, such as extra-soft foamed plastic, which reduces the damping of vibration and leads to a low variation in amplitude around the vibration bodies 11 and 12. When the hand pressure against the ring 43 of the steering wheel 4 increases, through a stronger grip from the driver, these forces are absorbed by the ring 43 of the steering wheel 4, while the vibration bodies 11 and 12 do not exert any other counteracting force that their own forces of deformation. In this way, significantly dampened vibration is limited when hand pressure increases.

FIG. 7 shows a cross-section C-C in FIG. 5, with the location of the vibrators 2 associated with the vibration bodies 11 and 12. The plastic external surface cover 45 of the ring 43 of the steering wheel 4 is sufficiently hard and shock-absorbent, such that no reinforcement 32 of the groove 451 is necessary in this approach.

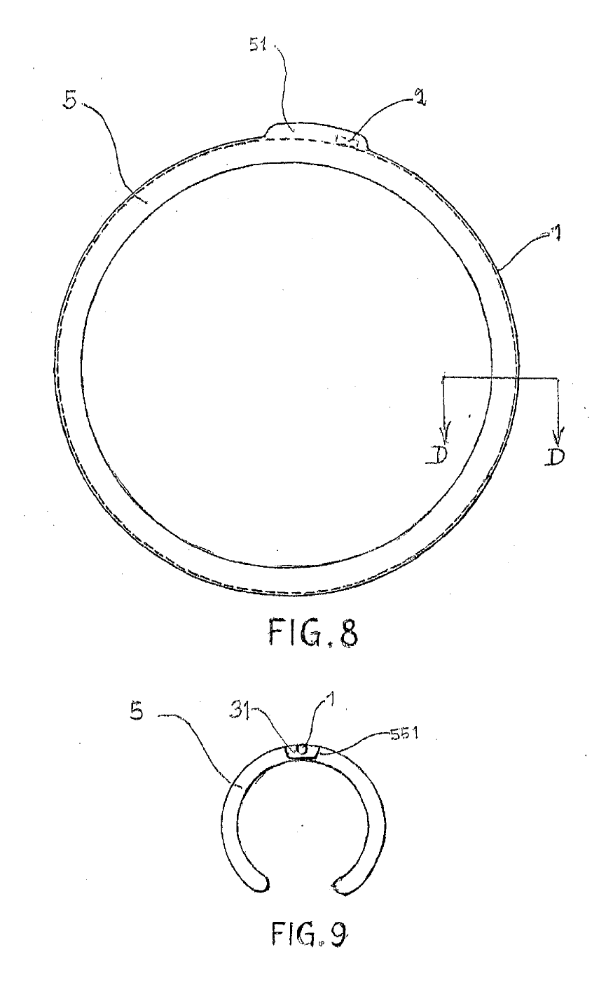

According to a second embodiment of the invention illustrated in FIGS. 8 and 9, the vibrator assembly 1, including the vibrator 2 and the vibration body 3, is located in a cover 5 that can be applied and removed, arranged to lie around the ring 43 of the steering wheel 4.

The reference number 5 in FIGS. 8 and 9 denotes an alternative cover for a steering wheel. The reference number 51 denotes a protuberance of the cover 5, and 551 denotes a groove in the cover 5.

The protuberance 51 contains a compartment for the vibrator 2 and an alarm-raising arrangement, which may be arranged as specified by the Swedish patent SE 539317, containing a detection component with a sensor for movement of the steering wheel and units for setting and indication, etc.

FIG. 8 shows the cover 5 equipped with a steering wheel vibrator assembly 1 according to the invention. The compartment of the protuberance 51 for the alarm-raising arrangement is suggested in FIG. 8.

The steering wheel vibrator assembly 1 in its design follows the same principles that have been described above for a steering wheel vibrator according to the invention installed in the steering wheel 4 and located in a groove 551 of the cover 5 in such a manner that the cover 5 absorbs forces of pressure from the hands without placing any pressure load onto the vibrator assembly 1 through it being positioned inside a very flexible spacer material 31 in the groove 551.

The power supply for the alarm-raising arrangement may be from a small battery and/or an electrical conductor with a contact, adapted to the cigarette lighter fitting of the vehicle, not shown in FIG. 8.

FIG. 9 shows a cross-section through D-D of the cover in FIG. 8, where the vibrator assembly 1 is located at the outer part of the cover 5 and rests against a flexible spacer material 31 in a groove 551 in the cover 5, as shown in FIG. 9.

According to a further embodiment of the invention, one or more steering wheel vibrator assemblies 1 are integrated into the cover 5 for the car steering wheel 4, which is equipped, in addition to this, with an alarm-raising arrangement.

Independently of the designs described above, it is a preferred embodiment that the vibrator 2 and the vibration body 3 are arranged such that the external surface cover 45 of the ring 43 of the steering wheel 4 vibrates with a frequency and an amplitude such that the Pacinian or Meissner corpuscles in the fingers or hands of the driver are stimulated. In the case in which two vibration bodies, such as the vibration bodies 11 and 12 each with a vibrator 2, are present, one of the vibration bodies 11 or 12 can vibrate with a frequency and an amplitude such that the Pacinian corpuscles are stimulated, while the other of vibration bodies 11 or 12 can vibrate with a frequency and an amplitude such that the Meissner corpuscles are stimulated.

The present invention solves the problems described in the introduction. The invention concerns an arrangement that can be designed to give an even, desired frequency and amplitude of vibration and an even distribution of the vibration around the ring 43 of the steering wheel 4. The arrangement can be generally used for vehicle steering wheels without extra fitting.

By using two steering wheel vibrator assemblies 1 separated from each other in the steering wheel 4, the invention makes possible, at the same time, the presence of two different frequencies around the ring 43 of the steering wheel 4, as is suggested in WO 2007/136 338 A1, and without any noticeable interference arising between these two vibrations.

Through the arrangement containing a vibration body 3 that has considerably less mass than the metal structure 44 of the steering wheel 4, considerably less electromotor energy will need to be supplied, while at the same time a haptic alarm obtains a higher quality through its even distribution and the distinctive character of its frequency.

It is obvious that one skilled in the art can develop alternative locations of the vibrator assembly 1 and other embodiments of the invention, and that such a person can modify the arrangements described and achieve the desired functionality, without deviating from the innovative concept of the present invention.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. It will be appreciated that the invention is susceptible to modification, variation, and change without departing from the proper scope and fair meaning of the accompanying claims.

1. A vibration arrangement for a vehicle steering wheel comprising:
one or more vibrators mounted to a ring of the steering wheel, the ring having a metallic part that is mechanically coupled to a steering wheel hub;
wherein at least one vibrator is arranged to produce a vibration frequency;
wherein the vibrator is mounted to a vibration body;
wherein the vibration body is elongated;
wherein the vibration body extends around at least a majority of the ring of the steering wheel without being in contact with the metallic part of the ring of the steering wheel; and
wherein the vibration body is positioned close to an external surface cover of the steering wheel that a driver grips when controlling the vehicle.

2. The vibration arrangement according to claim 1, wherein the vibration body is in the form of a rod.

3. The vibration arrangement according to claim 1, wherein the vibration body has two free ends, and the vibrator is mounted at at least one of the free ends.

4. The vibration arrangement according to claim 3, wherein the vibrator is mounted at the two free ends of the vibration body such that a closed ring is formed.

5. The vibration arrangement according to claim 1, wherein the vibration body is a closed ring, and the vibrator is mounted to the closed ring.

6. The vibration arrangement according to claim 1, 2 wherein the vibration body is arranged in or on the ring of the steering wheel, and the vibration body and the vibrator are surrounded by a soft and flexible material.

7. The vibration arrangement according to claim 1, wherein the vibration body is arranged in a groove or a track in the ring of the steering wheel, the groove or track located under an external surface cover of the ring of the steering wheel.

8. The vibration arrangement according to claim 1, wherein the vibration body is made of metal.

9. The vibration arrangement according to claim 1, wherein the vibrator is an imbalance motor.

10. The vibration arrangement according to claim 1, wherein the one or more vibrators comprises two or more vibrators, and each one of the two or more vibrators is coupled to an individual vibration body.

11. The vibration arrangement according to claim 10, wherein the vibration bodies lie separated from each other.

12. The vibration arrangement according to claim 10 wherein one of the two or more vibrators is located close to the upper side of the ring of the steering wheel and another of the two or more vibrators is located close to the lower side of the ring of the steering wheel, and the vibrators are configured to operate at different angular frequencies.

13. The vibration arrangement according to claim 1, further comprising a cover for extending about and being applied to and removed from the ring of the steering wheel, and wherein the vibrator and the vibration body are mounted within the cover.

14. The vibration arrangement according to claim 1, wherein the one or more vibrator and the one or more vibration body are arranged such that the external surface cover of the ring of the steering wheel vibrates with a frequency and an amplitude such that the Pacinian or Meissner corpuscles in the fingers or hands of the driver are stimulated.
